(19) United States
(12) Patent Application Publication
(10) Pub. No.: US 2007/0038605 A1
(43) Pub. Date: Feb. 15, 2007

(54) Method, system, and computer program product for providing unique identifiers for mail messages in web mail applications using JavaMail

(75) Inventor: Ramajeyam Gopalraj, Morrisville, NC (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/203,898

(22) Filed: Aug. 15, 2005

(51) Int. Cl. G06F 17/30

(52) U.S. Cl. 707/3

(57) ABSTRACT

The present invention provides unique identifiers for mail messages in web mail applications using JavaMail. A method in accordance with an embodiment of the present invention includes: providing a list of unique identifiers containing N entries, wherein N is equal to a total number of messages in a mail folder, and storing the list of unique identifiers indexed by an integer index; receiving a notification when a message is deleted from the mail folder; adding the unique identifier of the deleted message to a deleted identifier list, indexed by its integer index; receiving a request for a message in the message folder; obtaining the integer index of the requested message from the list of unique identifiers; deducting from the integer index of the requested message a number equal to the number of deleted messages in the deleted identifier list having an integer index less than or equal to the integer index of the requested message; and identifying the requested message in the mail folder using the resulting integer value from the deducting step.

### BACKGROUND OF THE INVENTION

1. Field of the Invention

The present invention generally relates to web mail applications, and more specifically relates to a method, system, and computer program product for providing unique identifiers for mail messages in web mail applications using JavaMail.

2. Related Art

JavaMail does not provide a reliable mechanism for session based web mail applications to identify messages in a mail folder during an HTTP (HyperText Transfer Protocol) session. The only identifier supported by JavaMail is the message number. In particular, in JavaMail, messages within a mail folder are sequentially numbered, from 1 through the total number of messages. This ordering is usually based on the arrival time of the messages in the folder. As each new message arrives into a mail folder, it is assigned a message number that is one higher than the previous number of messages in that mail folder.

An example of a JavaMail mail folder 10 is depicted in FIG. 1. As shown, the mail folder 10 contains five messages M₁, M₂, M₃, M₄, and M₅, which have been assigned message numbers 12 of 1, 2, 3, 4, and 5, respectively. A browser client can access a particular message in the mail folder 10 based on its message number 12. For example, a browser client can access the message M₃ from the mail folder 10 using the message number 12 of “3.”

Unfortunately, the message numbers 12 can change when messages are expunged from or added to the mail folder 10. For example, if the messages M₁ and M₃ are expunged from the mail folder 10, the remaining messages in the mail folder 10 are sequentially renumbered as shown in FIG. 2. As such, the message number 12 of “3” now references the message M₅ in the mail folder 10 instead of the message M₃ as in FIG. 1. When another message M₆ is subsequently added to the mail folder 10 as shown in FIG. 3, the message M₆ is referenced by the message number 12 “4,” which originally referenced the message M₄ in FIG. 1.

To address the above-described situation, the JavaMail specification 1.3.1 suggests using Message objects rather than message numbers as cached references to messages in a mail folder. Unfortunately, this can negatively affect server performance because Message objects can consume a substantial amount of memory on a server once they are fully fetched. Hence, there is a need for a mechanism that is both reliable and efficient in terms of server performance for identifying messages in a mail folder during an HTTP session.

### SUMMARY OF THE INVENTION

In general, the present invention provides a method, system, and computer program product for providing unique identifiers for mail messages in web mail applications using JavaMail.

A first aspect of the present invention is directed to method for identifying mail messages in a mail folder, comprising: providing a list of unique identifiers containing N entries, wherein N is equal to a total number of messages in a mail folder, and storing the list of unique identifiers indexed by an integer index; receiving a notification when a message is deleted from the mail folder; adding the unique identifier of the deleted message to a deleted identifier list, indexed by its integer index; receiving a request for a message in the message folder; obtaining the integer index of the requested message from the list of unique identifiers; deducting from the integer index of the requested message a number equal to the number of deleted messages in the deleted identifier list having an integer index less than or equal to the integer index of the requested message; and identifying the requested message in the mail folder using a resulting integer value from the deducting step.

A second aspect of the present invention is directed to a system for identifying mail messages in a mail folder, comprising: a system for providing a list of unique identifiers containing N entries, wherein N is equal to a total number of messages in a mail folder, and for storing the list of unique identifiers indexed by an integer index; a system for receiving a notification when a message is deleted from the mail folder; a system for adding the unique identifier of the deleted message to a deleted identifier list, indexed by its integer index; a system for receiving a request for a message in the message folder; a system for obtaining the integer index of the requested message from the list of unique identifiers; a system for deducting from the integer index of the requested message a number equal to the number of deleted messages in the deleted identifier list having an integer index less than or equal to the integer index of the requested message; and a system for identifying the requested message in the mail folder using the resulting integer value from the deducting step.

A third aspect of the present invention is directed to a program product stored on a computer readable medium for identifying mail messages in a mail folder, the computer readable medium comprising program code for performing the following steps: providing a list of unique identifiers containing N entries, wherein N is equal to a total number of messages in the mail folder, and storing the list of unique identifiers indexed by an integer index; receiving a notification when a message is deleted from the mail folder; adding the unique identifier of the deleted message to a deleted identifier list, indexed by its integer index; receiving a request for a message in the message folder; obtaining the integer index of the requested message from the list of unique identifiers; deducting from the integer index of the requested message a number equal to the number of deleted messages in the deleted identifier list having an integer index less than or equal to the integer index of the requested message; and identifying the requested message in the mail folder using the resulting integer value from the deducting step.

A fourth aspect of the present invention is directed to a method for deploying an application for identifying mail messages in a mail folder, comprising: providing a computer infrastructure being operable to: provide a list of unique identifiers containing N entries, wherein N is equal to a total number of messages in the mail folder, and store the list of unique identifiers indexed by an integer index; receive a notification when a message is deleted from the mail folder; add the unique identifier of the deleted message to a deleted identifier list, indexed by its integer index; receive a request for a message in the message folder; obtain the integer index of the requested message from the list of unique identifiers; deduct from the integer index of the requested message a number equal to the number of deleted messages in the deleted identifier list having an integer index less than or equal to the integer index of the requested message; and identify the requested message in the mail folder using the resulting integer value from the deducting step.

A fifth aspect of the present invention is directed to computer software embodied in a propagated signal for identifying mail messages in a mail folder, the computer software comprising instructions to cause a computer system to perform the following functions: provide a list of unique identifiers containing N entries, wherein N is equal to a total number of messages in the mail folder, and store the list of unique identifiers indexed by an integer index; receive a notification when a message is deleted from the mail folder; add the unique identifier of the deleted message to a deleted identifier list, indexed by its integer index; receive a request for a message in the message folder; obtain the integer index of the requested message from the list of unique identifiers; deduct from the integer index of the requested message a number equal to the number of deleted messages in the deleted identifier list having an integer index less than or equal to the integer index of the requested message; and identify the requested message in the mail folder using the resulting integer value from the deducting step.

### BRIEF DESCRIPTION OF THE DRAWINGS

These and other features of this invention will be more readily understood from the following detailed description of the various aspects of the invention taken in conjunction with the accompanying drawings in which:

FIGS. 1-3 depict the process of reassigning message numbers in a mail folder when messages are expunged/added.

FIG. 4 depicts an illustrative system for providing unique identifiers for mail messages in web mail applications using JavaMail in accordance with an embodiment of the present invention.

FIG. 5 depicts a flow diagram of a method for fetching mail message summary data for messages in a mail folder in accordance with an embodiment of the present invention.

FIGS. 6 depicts a flow diagram of a method for creating an instance of a MessageList object in accordance with an embodiment of the present invention.

FIG. 7 depicts an illustrative list of unique IDs in accordance with an embodiment of the present invention

FIG. 8 depicts a flow diagram of a process that occurs when a message is added to or deleted from a mail folder in accordance with an embodiment of the present invention.

FIG. 9 depicts a flow diagram of a process that occurs when a browser client requests a message having a specific ID from a mail folder in accordance with an embodiment of the present invention.

FIG. 10 depicts an illustrative computer system for implementing embodiment(s) of the present invention.

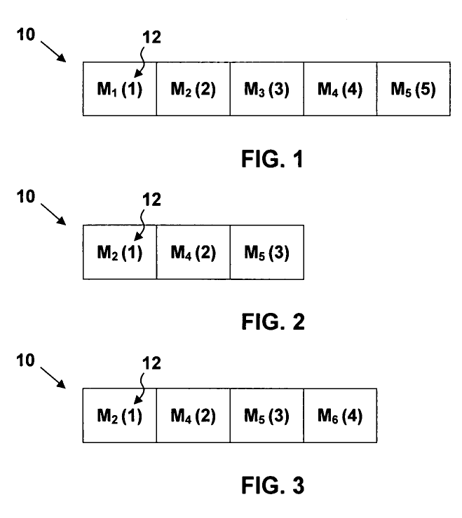

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

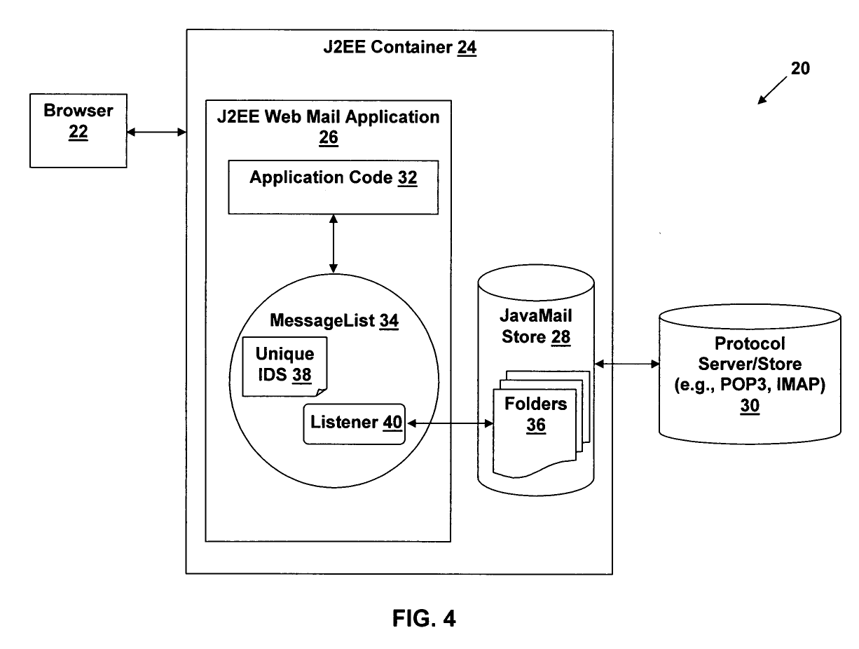

An illustrative system 20 for providing unique identifiers for mail messages in web mail applications using JavaMail in accordance with an embodiment of the present invention is depicted in FIG. 4. In the following discussion, it is assumed that the reader has a knowledge of JavaMail and Java programming commensurate with one skilled in the art. Accordingly, a detailed description of JavaMail is not provided herein.

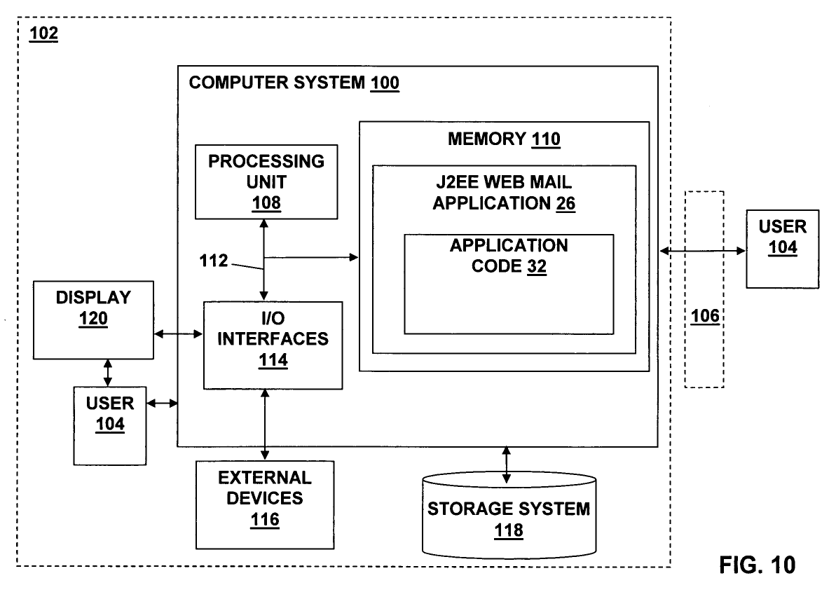

The system 20 generally comprises a browser client 22, a J2EE container 24 including a J2EE web mail application 26 and JavaMail store 28, and a protocol server/store 30 (e.g., POP3, IMAP, etc.). The J2EE web mail application 26 includes application code 32 and an instance of a MessageList object 34 associated with a mail folder 36 stored in the JavaMail store 28. The MessageList object 34 includes a list 38 of unique IDs and a FolderListener 40. An illustrative computer system 100 for implementing the J2EE web mail application 26 of the present invention is depicted in FIG. 10.

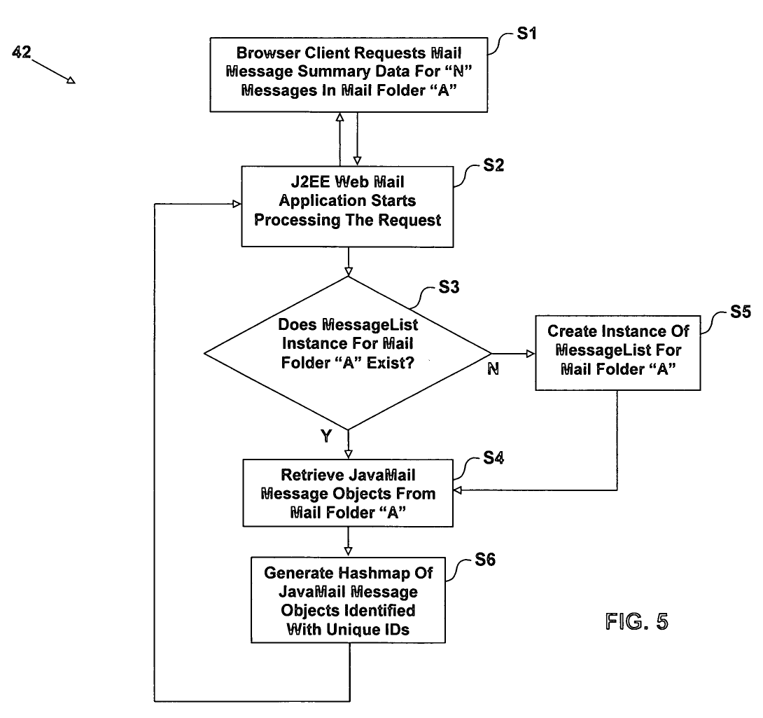

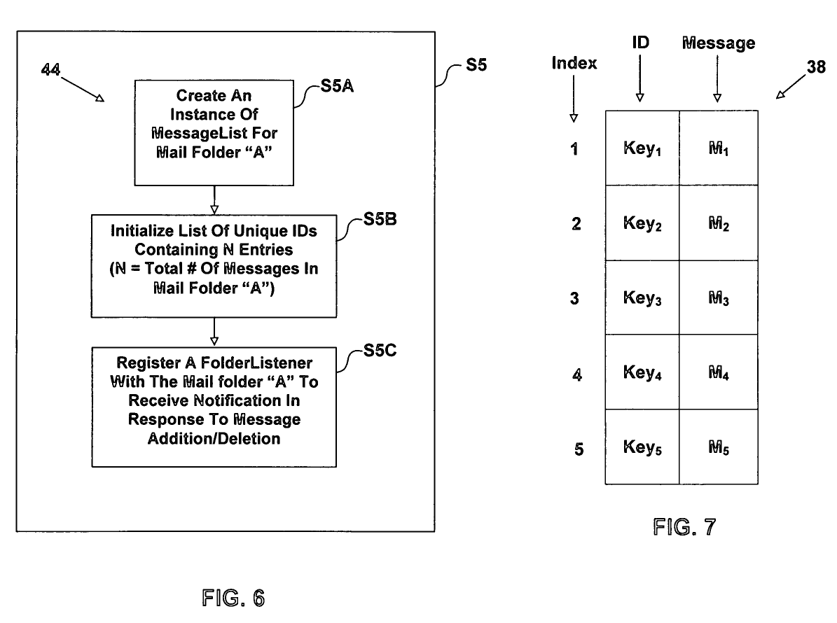

A flow diagram 42 of a method for fetching mail message summary data for messages in a mail folder 36 “A” in accordance with an embodiment of the present invention is illustrated in FIG. 5. A flow diagram 44 of a method for creating an instance of a MessageList object 34 in accordance with an embodiment of the present invention is illustrated in FIG. 6. The flow diagrams 42 and 44 are described below with reference to the components of the system 20 illustrated in FIG. 4.

In step S1 of the flow diagram 42, the browser client 22 requests mail message summary data for the “N” messages in the mail folder 36 “A.” In step S2, the J2EE web mail application 26 starts processing the request for the message summary data. In step S3, if an instance of an MessageList object 34 exists for the mail folder 36 “A,” then the JavaMail message objects in the mail folder 36 “A” are retrieved from the JavaMail store 28 in step S4. If not, an instance of the MessageList object 34 for the mail folder 36 “A” is created in step S5 and the JavaMail message objects in the mail folder 36 “A” are retrieved from the JavaMail store 28 in step S4. After the JavaMail message objects have been retrieved from the mail folder 36 “A,” a hashmap of the retrieved JavaMail message objects identified with unique IDs is returned in step S6.

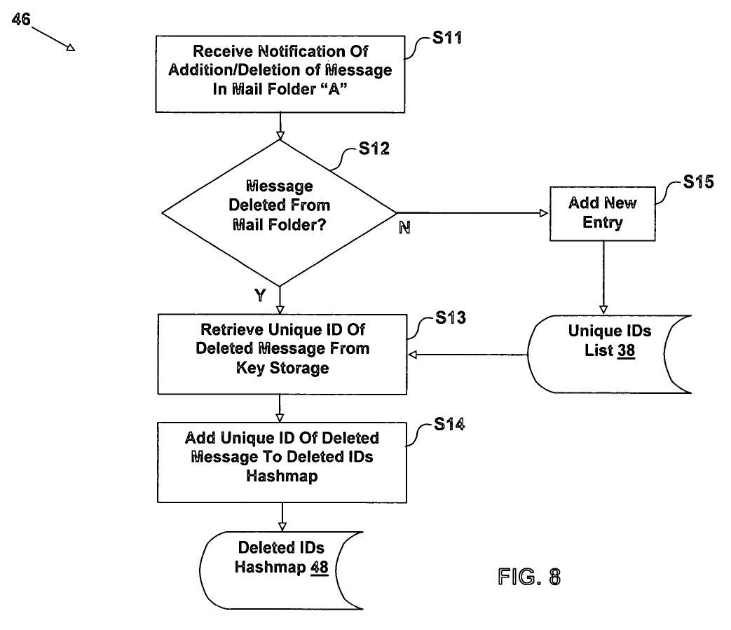

The creation of an instance of a MessageList object 34 for the mail folder 36 “A” (step S5, FIG. 5) is illustrated in greater detail in the flow diagram 44 of FIG. 6. In step S5A, a new instance of the MessageList object 34 is created for the mail folder 36 “A.” In step S5B, a list 38 of unique IDs containing N entries is initialized, where N is the total number of messages in the mail folder “A.” The list 38 of unique IDs is indexed by an integer index. A illustrative representation of a list 38 of unique IDs for the mail folder 36 “A” containing five (N=5) messages M₁, M₂, M₃, M₄, and M₅, is illustrated in FIG. 7. In step 5C, a FolderListener 40 is registered with the mail folder 36 “A” to receive notification of message addition/deletion.

A flow diagram 46 illustrating the process that occurs when a message is added to or deleted from the mail folder 36 “A” in accordance with an embodiment of the present invention is illustrated in FIG. 8. In step S11, the FolderListener 40 (FIG. 4) receives notification of the addition/deletion of a message in the mail folder 36 “A.” If it is determined in step S12 that an existing message has been deleted from the mail folder 36 “A,” then the unique ID of the deleted message is retrieved from key storage in step S13. The unique ID of the deleted message is then added in step S14 to a deleted IDs hashmap 48, indexed by the same integer index used in the list 38 of unique IDs. If it is determined in step S12 that a new message has been added to the mail folder 36 “A,” then a new entry is added in step S15 to the list 38 of unique IDs.

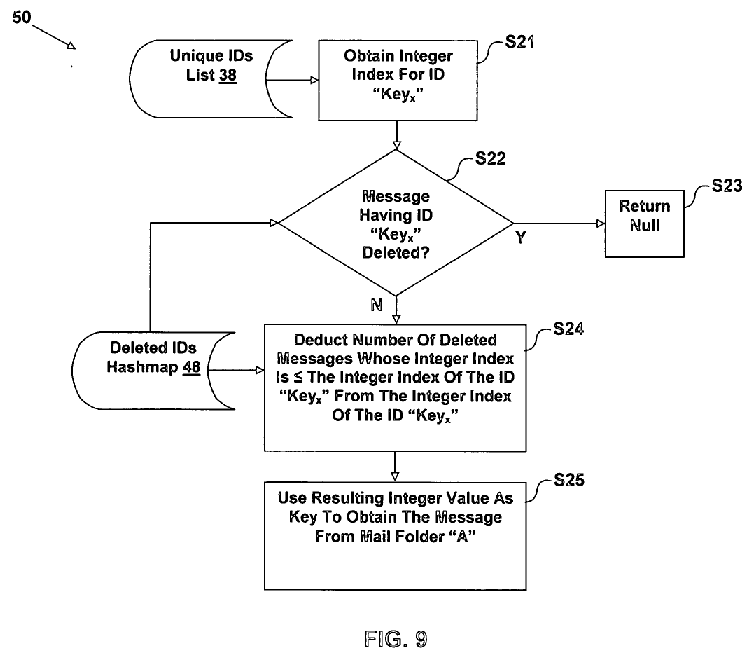

A flow diagram 50 illustrating the process that occurs when the browser client 12 (FIG. 4) requests a message having an ID “Keyₓ” from the mail folder 36 “A” in accordance with the present invention is illustrated in FIG. 9. In step S21, the integer index for the ID “Keyₓ” is obtained from key storage. If it is determined in step S22 that the ID “Keyₓ” is in the deleted IDs hashmap 48, then a “Null” is returned to the browser client 22 in step S23, indicating that the requested message does not exist in the mail folder 36 “A.” If not, then in step S24, the number of messages that have been deleted from the mail folder 36 “A” (as determined from the deleted IDs hashmap 48), and whose integer index is less than or equal to the integer index of the ID “Keyₓ,” is deducted from the integer index of the ID “Keyₓ.” Next, in step S25, the resulting integer value from step S24 is used as the key to obtain the requested message from the mail folder 36 “A.”

As an example of the process detailed in FIG. 9, assume that the messages M₂ and M₃ have been deleted from the mail folder 36 “A” and that the browser client 12 has requested the message M₄. This scenario results in a situation similar to that shown in FIG. 2, where message M₄ has been reassigned the message number “2.” In this case, the integer index for the ID “Key₄” corresponding to message M₄ is found to be “4” (see FIG. 7) in step S21. Next, in step S24, the number “2” is deducted from “4,” since two messages (i.e., M₂ and M₃) whose integer index is less than or equal to “4” have been deleted from the mail folder 36 “A.” Next, in step S25, the resultant value of “2” is used as a key to obtain the requested message M₄ from the mail folder 36 “A.”

The present invention can be implemented, for example, using the following illustrative code:

Example Code:

```
public class MessageList implements MessageCountListener {
  private List _msgKeys;
  private Map _deletions;
  private Folder _folder;
  public MessageList (Folder folder) throws MessagingException {
```

```
if (!folder.isOpen( )) {
  folder.open(Folder.READ_WRITE);
}
_folder = folder;
int count = _folder.getMessageCount( );
//generete unique key for messages in folder
_msgKeys = new ArrayList((count > 0) ? count : 0);
if (count > 0) {
  for (int i = 0; i < count; i++) {
```

_msgKeys.add(GuidGenerator.next( ));

}
}
//register a listener
_folder.addMessageCountListener(this);

```
  }
  //Called when messages are added to the folder
  public synchronized void messagesAdded(MessageCountEvent e) {
```

Message[] messages = e.getMessages( );
//append the key for newly added messages into our unique
//key list
if (messages != null && messages.length > 0) {
for (int i = 0; i < messages.length; i++) {

_msgKeys.add(GuidGenerator.next( ));

}
}

```
  }
  //Called when messages are deleted from folder
  public synchronized void messagesRemoved(MessageCountEvent e) {
```

Message[] messages = e.getMessages( );
//add the unique keys of deleted messages into our
//deletions map
if (messages != null && messages.length > 0) {
for (int i = 0; i < messages.length; i++) {

int n = messages[i].getMessageNumber( );
int m = getListIndex(n);
if (m >= 0 && m < _msgKeys.size( )) {
_additions.put(_msgKeys.get(m), new

Integer(n));

}

}
}

```
  }
  //Retrieve a message by unique key
  public synchronized Message getMessage(String key)
```

```
throws MessagingException {
Message msg = null;
if(_deletions.containsKey(key)) return null;
//locate the index of the given key and then locate the
//message in folder
if (key != null && _msgKeys != null) {
  ListIterator listIterator = _msgKeys.listIterator( );
  int index = −1;
  while (listIterator.hasNext( )) {
```

```
++index;
if (key.equals(listIterator.next( ))) {
  index = getFolderIndex(index);
  int count = _folder.getMessageCount( );
  if (index >= 1 && index <= count) {
```

msg = _folder.getMessage(index);

```
  }
  break;
}
```

}
}
return msg;

```
  }
  //Translate unique key list index into folder index (used to
  //retrieve the message)
  private int getFolderIndex(int listIndex) {
```

```
int folderIndex = listIndex + 1;
if (_deletions != null) {
  Iterator iterator = _deletions.values( ).iterator( ) ;
  while (iterator.hasNext( )) {
```

Integer item = (Integer) iterator.next( );
if (item.intValue( ) <= listIndex)
folderIndex++;

}
}
return folderIndex;

```
  }
  //Translate the folder index into unique key list index (used to
  //retrieve the unique key)
  private int getListIndex(int folderIndex) {
```

```
int listIndex = folderIndex - 1;
if (_deletions != null) {
  Iterator iterator = _deletions.values( ).iterator( );
  while (iterator.hasNext( )) {
```

Integer item = (Integer) iterator.next( );
if (item.intValue( ) <= folderIndex)
listIndex--;

}
}
return listIndex;

}

A computer system 100 for providing unique identifiers for mail messages in web mail applications using JavaMail in accordance with an embodiment of the present invention is depicted in FIG. 10. Computer system 100 is provided in a computer infrastructure 102. Computer system 100 is intended to represent any type of computer system capable of carrying out the teachings of the present invention. For example, computer system 100 can be a laptop computer, a desktop computer, a workstation, a handheld device, a server, a cluster of computers, etc. In addition, as will be further described below, computer system 100 can be deployed and/or operated by a service provider that provides a service for providing unique identifiers for mail messages in web mail applications using JavaMail in accordance with the present invention. It should be appreciated that a user 104 can access computer system 100 directly, or can operate a computer system that communicates with computer system 100 over a network 106 (e.g., the Internet, a wide area network (WAN), a local area network (LAN), a virtual private network (VPN), etc). In the case of the latter, communications between computer system 100 and a user-operated computer system can occur via any combination of various types of communications links. For example, the communication links can comprise addressable connections that can utilize any combination of wired and/or wireless transmission methods. Where communications occur via the Internet, connectivity can be provided by conventional TCP/IP sockets-based protocol, and an Internet service provider can be used to establish connectivity to the Internet.

Computer system 100 is shown including a processing unit 108, a memory 110, a bus 112, and input/output (I/O) interfaces 114. Further, computer system 100 is shown in communication with external devices/resources 116 and one or more storage systems 118. In general, processing unit 108 executes computer program code, such as J2EE web mail application 26, that is stored in memory 110 and/or storage system(s) 118. While executing computer program code, processing unit 108 can read and/or write data, to/from memory 110, storage system(s) 118, and/or I/O interfaces 114. Bus 112 provides a communication link between each of the components in computer system 100. External devices/resources 116 can comprise any devices (e.g., keyboard, pointing device, display (e.g., display 120, printer, etc.) that enable a user to interact with computer system 100 and/or any devices (e.g., network card, modem, etc.) that enable computer system 100 to communicate with one or more other computing devices.

Computer infrastructure 102 is only illustrative of various types of computer infrastructures that can be used to implement the present invention. For example, in one embodiment, computer infrastructure 102 can comprise two or more computing devices (e.g., a server cluster) that communicate over a network (e.g., network 106) to perform the various process steps of the invention. Moreover, computer system 100 is only representative of the many types of computer systems that can be used in the practice of the present invention, each of which can include numerous combinations of hardware/software. For example, processing unit 108 can comprise a single processing unit, or can be distributed across one or more processing units in one or more locations, e.g., on a client and server. Similarly, memory 110 and/or storage system(s) 118 can comprise any combination of various types of data storage and/or transmission media that reside at one or more physical locations. Further, I/O interfaces 114 can comprise any system for exchanging information with one or more external devices/resources 116. Still further, it is understood that one or more additional components (e.g., system software, communication systems, cache memory, etc.) not shown in FIG. 10 can be included in computer system 100. However, if computer system 100 comprises a handheld device or the like, it is understood that one or more external devices/resources 116 (e.g., a display) and/or one or more storage system(s) 118 can be contained within computer system 100, and not externally as shown.

Storage system(s) 118 can be any type of system (e.g., a database) capable of providing storage for information under the present invention. To this extent, storage system(s) 118 can include one or more storage devices, such as a magnetic disk drive or an optical disk drive. In another embodiment, storage system(s) 118 can include data distributed across, for example, a local area network (LAN), wide area network (WAN) or a storage area network (SAN) (not shown). Moreover, although not shown, computer systems operated by user 104 can contain computerized components similar to those described above with regard to computer system 100.

Shown in memory 110 (e.g., as a computer program product) is an a J2EE web mail application 26 that includes application code 32 for providing unique identifiers for mail messages in accordance with embodiments of the present invention. The application code 32 (e.g., the example code listed above) is configured to initiate an instance of a MessageList object 34 associated with a mail folder 36 stored in, for example, storage system 118, update a list 38 of unique IDs in response to the addition/deletion of messages in the mail folder 36, generate a deleted IDs hashmap 48 and update the deleted IDs hashmap 48 accordingly in response to the deletion of messages from the mail folder 36, and provide an identifier that correctly points to a desired message in the mail folder 36 in response to a request for that message from a browser client.

The present invention can be offered as a business method on a subscription or fee basis. For example, one or more components of the present invention can be created, maintained, supported, and/or deployed by a service provider that offers the functions described herein for customers. That is, a service provider can be used to provide a service for providing unique identifiers for mail messages in web mail applications using JavaMail, as described above.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized. The present invention can also be embedded in a computer program product or a propagated signal, which comprises all the respective features enabling the implementation of the methods described herein, and which—when loaded in a computer system—is able to carry out these methods.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid state memory, magnetic tape, removable computer diskette, random access memory (RAM), read-only memory (ROM), rigid magnetic disk and optical disk. Current examples of optical disks include a compact disk—read only disk (CD-ROM), a compact disk—read/write disk (CD-R/W), and a digital versatile disk (DVD).

Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A method for identifying mail messages in a mail folder, comprising:
providing a list of unique identifiers containing N entries, wherein N is equal to a total number of messages in the mail folder, and storing the list of unique identifiers indexed by an integer index;
receiving a notification when a message is deleted from the mail folder;
adding the unique identifier of the deleted message to a deleted identifier list, indexed by its integer index;
receiving a request for a message in the message folder;
obtaining the integer index of the requested message from the list of unique identifiers;
deducting from the integer index of the requested message a number equal to the number of deleted messages in the deleted identifier list having an integer index less than or equal to the integer index of the requested message; and
identifying the requested message in the mail folder using the resulting integer value from the deducting step.

2. The method of claim 1, wherein the mail folder comprises a JavaMail mail folder.

3. The method of claim 1, wherein the deleted identifier list comprises a hashmap.

4. The method of claim 1, further comprising:
providing an instance of a MessageList object associated with the mail folder, wherein the MessageList object includes the list of unique identifiers and a FolderListener for receiving a notification of an addition or deletion of a message from the mail folder.

5. The method of claim 1, further comprising:
receiving a notification when a new message is added to the mail folder; and
adding an integer index for the new message to the list of unique identifiers.

6. A system for identifying mail messages in a mail folder, comprising:
a system for providing a list of unique identifiers containing N entries, wherein N is equal to a total number of messages in the mail folder, and for storing the list of unique identifiers indexed by an integer index;
a system for receiving a notification when a message is deleted from the mail folder;
a system for adding the unique identifier of the deleted message to a deleted identifier list, indexed by its integer index;
a system for receiving a request for a message in the message folder;
a system for obtaining the integer index of the requested message from the list of unique identifiers;
a system for deducting from the integer index of the requested message a number equal to the number of deleted messages in the deleted identifier list having an integer index less than or equal to the integer index of the requested message; and
a system for identifying the requested message in the mail folder using the resulting integer value from the deducting step.

7. The system of claim 6, wherein the mail folder comprises a JavaMail mail folder.

8. The system of claim 6, wherein the deleted identifier list comprises a hashmap.

9. The system of claim 6, further comprising:
a system for providing an instance of a MessageList object associated with the mail folder, wherein the MessageList object includes the list of unique identifiers and a FolderListener for receiving a notification of an addition or deletion of a message from the mail folder.

10. The system of claim 6, further comprising:
a system for receiving a notification when a new message is added to the mail folder; and
a system for adding an integer index for the new message to the list of unique identifiers.

11. A program product stored on a computer readable medium for identifying mail messages in a mail folder, the computer readable medium comprising program code for performing the following steps:
providing a list of unique identifiers containing N entries, wherein N is equal to a total number of messages in the mail folder, and storing the list of unique identifiers indexed by an integer index;
receiving a notification when a message is deleted from the mail folder;
adding the unique identifier of the deleted message to a deleted identifier list, indexed by its integer index;
receiving a request for a message in the message folder;
obtaining the integer index of the requested message from the list of unique identifiers;
deducting from the integer index of the requested message a number equal to the number of deleted messages in the deleted identifier list having an integer index less than or equal to the integer index of the requested message; and
identifying the requested message in the mail folder using the resulting integer value from the deducting step.

12. The program product of claim 11, wherein the mail folder comprises a JavaMail mail folder.

13. The program product of claim 11, wherein the deleted identifier list comprises a hashmap.

14. The program product of claim 11, further comprising:
providing an instance of a MessageList object associated with the mail folder, wherein the MessageList object includes the list of unique identifiers and a FolderListener for receiving a notification of an addition or deletion of a message from the mail folder.

15. The program product of claim 11, further comprising:
receiving a notification when a new message is added to the mail folder; and
adding an integer index for the new message to the list of unique identifiers.

16. A method for deploying an application for identifying mail messages in a mail folder, comprising: providing a computer infrastructure being operable to:
provide a list of unique identifiers containing N entries, wherein N is equal to a total number of messages in the mail folder, and store the list of unique identifiers indexed by an integer index;
receive a notification when a message is deleted from the mail folder;
add the unique identifier of the deleted message to a deleted identifier list, indexed by its integer index;
receive a request for a message in the message folder;
obtain the integer index of the requested message from the list of unique identifiers;
deduct from the integer index of the requested message a number equal to the number of deleted messages in the deleted identifier list having an integer index less than or equal to the integer index of the requested message; and
identify the requested message in the mail folder using the resulting integer value from the deducting step.

17. Computer software embodied in a propagated signal for identifying mail messages in a mail folder, the computer software comprising instructions to cause a computer system to perform the following functions:
provide a list of unique identifiers containing N entries, wherein N is equal to a total number of messages in the mail folder, and store the list of unique identifiers indexed by an integer index;
receive a notification when a message is deleted from the mail folder;
add the unique identifier of the deleted message to a deleted identifier list, indexed by its integer index;
receive a request for a message in the message folder;
obtain the integer index of the requested message from the list of unique identifiers;
deduct from the integer index of the requested message a number equal to the number of deleted messages in the deleted identifier list having an integer index less than or equal to the integer index of the requested message; and
identify the requested message in the mail folder using the resulting integer value from the deducting step.
